(19) United States
(12) Patent Application Publication
(10) Pub. No.: US 2004/0222664 A1
(43) Pub. Date: Nov. 11, 2004

(54) Vehicle having maximized usable bed width

(76) Inventor: Wilfred Helfrich, Oxford, MI (US)

Correspondence Address: Marc J. Luddy, DaimlerChrysler Intellectual Capital Corporation, CIMS 483-02-19, 800 Chrysler Drive, Auburn Hills, MI, 48326-2757, US

(21) Appl. No.: 10/435,213

(22) Filed: May 9, 2003

(51) Int. Cl. B60N 2/00

(52) U.S. Cl. 296/183.1

(57) ABSTRACT

A wide bed vehicle including: a frame having a front portion, a rear portion; a first wheel fixed to the front portion of the frame and parallel to it; a second wheel fixed to the front portion of the frame parallel to the first wheel and parallel to the frame; a third wheel fixed to the rear portion of the frame parallel to the frame outward of the first wheel; a fourth wheel fixed to the rear portion of the frame parallel and parallel to it, parallel to the third wheel, and outward of the second wheel; a cab fixed to the front portion of the frame, covering the first wheel and the second wheel; a rear bed fixed to the rear portion of the frame between the third wheel and the fourth wheel, the rear bed enclosing the third wheel and the fourth wheel in outwardly protruding wheel wells.

### FIELD OF THE INVENTION

This invention relates to a vehicle configured to have the maximized bed width possible. More specifically, this invention relates to a vehicle with a body having offset rear wheels that permit the vehicle bed to be constructed without interior wheel well flares such that the bed has a uniform width for its entire length.

### BACKGROUND OF THE INVENTION

At their inception, powered vehicles were little more than horse drawn carriages with an engine instead of a horse. Material limitations of the time dictated that the body style of carriages, regardless off their power source, was based on a box. Not surprisingly, early production vehicles followed this body style. A rectangular box was positioned between the wheels on the axles with a bench seat in the front and additional seats or cargo space in the rear.

This started to change in the 1950's as aircraft became the model for vehicle design. “Streamlined” vehicle bodies appeared and designers moved the wheels inside the exterior lines of the vehicle. Eliminated were the ubiquitous exterior fender bulges that had been a uniform design feature since the 1920's and a new ubiquitous interior feature took their place: interior bulges to accommodate the rear wheels. In such vehicles, a wide rear seat stretched between the interior rear wheel humps and suddenly four or five kids (in pre-seatbelt days) could sit side by side. For the users of pickup trucks, vans, and the like, the increased bed size permitted hauling more without the need for a larger overall vehicle.

With a few exceptions, interior wheel humps have been the standard for pickups, vans, and related vehicles since the 1960's. But the increased bed size of these vehicles has a major drawback: the wheel wells create irregular spaces. A desire to use these spaces have spawned lengthwise cabinets, widthwise toolboxes, and all manner of shelves and racks. Storage cabinets that fit parallel to the side walls of the truck bed and around the wheel humps are described in U.S. Pat. Nos. 4,201,414; 4,746,161; and 6,003,923. Boxes for use in pickup trucks that are oriented widthwise in the open bed immediately behind the cab and in front of the wheel well humps are described in U.S. Pat. Nos. 5,685,467 and 6,507,701 B2.

While the toolboxes described above, provide additional storage space, the maximum total usable width of the vehicle bed for large items such as sheets of plywood and drywall is still determined by the distance between the inside walls of the rear wheel wells protruding into the vehicle bed. This problem is partially addressed through the use of a bed extender that works with a fold down tailgate. Embodiments of such extenders are described in U.S. Pat. Nos. 6,340,190 B1; 6,378,926 B1; and 6,513,850 B1. These devices permit the use of the entire area of the truck from the rearmost portion of the protruding interior wheel wells almost to the edge of the folded down tailgate.

However, such extenders often do not extend far enough, they expose sheets of material to damage, the amount of weight that can be supported is limited by the strength of the tailgate, and they cannot be used in vehicles such as vans and SUVs that do not have tailgates.

A device that combines storage units with the ability to take advantage of the full area of the vehicle bed from sidewall to sidewall is described in U.S. Pat. No. 6,318,781 B1. This patent describes a detailed embodiment of the well known method of maximizing the usable square footage of a vehicle bed by building a deck that partially rests on the tops of the protruding wheel well humps and extends from sidewall to sidewall. Advantageously, such a deck can be used in an open pickup truck, a pickup truck with a topper, a van without seats, small commercial vehicles, mini-vans, etc. Such a deck is a particularly useful do-it-yourself addition that permits two people to sleep side by side with plenty of room with for storage underneath. A disadvantage of this arrangement is that loads must be lifted some distance above the vehicle bed. In addition, while the amount of space available to lie down in is increased, the interior head room is significantly reduced.

Vehicles are available with the rear bed raised entirely over the rear wheels. Buses, some full size vans, and “stake trucks” commonly make use of such a construction. But the rear bed in such vehicles is so high that stairs or lifting devices must be provided to assist with entry or loading.

The widest bed pickup trucks, trucks, vans, minivans, etc. having a reasonable bed height (meaning the bed is positioned between the rear wheels) currently manufactured have a rear bed that is approximately four feet in width by eight feet in length. This size bed has become the unofficial maximum in order to accommodate a standard sheet of plywood, drywall, etc. So ubiquitous is the four by eight foot maximum that a number of products, such as garden trackers, all terrain vehicles, etc., are manufacture specifically to fit in this space.

However, this standard size is no longer practical for many applications. One often sees pickup trucks containing a garden tractor surrounded by other lawn equipment or a pickup towing an all terrain vehicle on a trailer with a second all terrain vehicle in the back of the pickup. In addition, the usefulness of second and third row seats is diminished because the interior wheel well restricts how far the rear window can roll down, restricts the width of the seat, intrudes in the foot space, prevents seats from being moved longitudinally, etc.

### SUMMARY OF THE INVENTION

One object of the invention is a vehicle having a wide, easily accessible bed.

Another object of the invention is a simple but elegant design for a vehicle having a low cost, wide, uniformly shaped bed or box that that is easily accessible.

These and other objects of the invention are provided by a wide bed vehicle comprising: a frame having a front portion, a rear portion, and a central longitudinal axis. A first wheel is fixed to the front portion of the frame parallel to the central longitudinal axis, and a second wheel is fixed to the front portion of the frame parallel to the first wheel and parallel to the central longitudinal axis. A third wheel is fixed to the rear portion of the frame parallel to the central longitudinal axis outward of the first wheel, and a fourth wheel is fixed to the rear portion of the frame parallel to the central longitudinal axis, parallel to the third wheel, and outward of the second wheel. A cab is fixed to the front portion of the frame, covering the first wheel and the second wheel, and a rear bed is fixed to the rear portion of the frame between the third wheel and the fourth wheel. The rear bed encloses the third wheel and the fourth wheel in outwardly protruding wheel wells.

Objects of the invention are also satisfied by a wide bed vehicle comprising: a frame having a front portion, a rear portion, and a central longitudinal axis; a first wheel fixed to the front portion of the frame parallel to the central longitudinal axis; a second wheel fixed to the front portion of the frame parallel to the first wheel and parallel to the central longitudinal axis; a third wheel fixed to the rear portion of the frame parallel to the central longitudinal axis outward of the first wheel; a fourth wheel fixed to the rear portion of the frame parallel to the central longitudinal axis, parallel to the third wheel, and outward of the second wheel; a cab area fixed to the front portion of the frame, covering the first wheel and the second wheel; a rear bed area fixed to the rear portion of the frame between the third wheel and the fourth wheel.

### BRIEF DESCRIPTION OF THE DRAWINGS

FIG. 1 is a perspective view of a pickup truck bed according to the prior art.

FIG. 2 is a longitudinal section of a pickup truck configured according to the prior art.

FIG. 3 is a longitudinal section of a conventional standard art minivan showing the configuration and positioning of the seats relative to the wheels.

FIG. 4 is a perspective view of a pickup truck bed according to the current invention.

FIG. 5 is a longitudinal section of a framed vehicle at the frame level configured according to the current invention.

FIG. 6 is a longitudinal section of a vehicle according to the invention showing the configuration and positioning of the vehicle bed relative to the wheels and the cab.

FIG. 7 is a longitudinal section of a minivan according to the invention showing the configuration and positioning of the seats relative to the wheels.

FIG. 8 is a longitudinal section of a minivan showing the configuration and positioning of the seats relative to the wheels in an alternate embodiment of the invention.

### DETAILED DESCRIPTION OF THE INVENTION

A vehicle to which the present invention applies can be a vehicle where the body parts are attached to a frame or a unibody vehicle where the body parts (cab and rear bed) are combined with stress-bearing elements (reduced frame) to form the body and chassis as a single piece. Such vehicles are, for example, pickup trucks of any size, vans, minivans, SUVs, etc. While certain specific description and figures may be directed toward a pickup truck, for example, it should be understood that the description applies equally to all the vehicle types described herein. Like numbers are used to identify like parts.

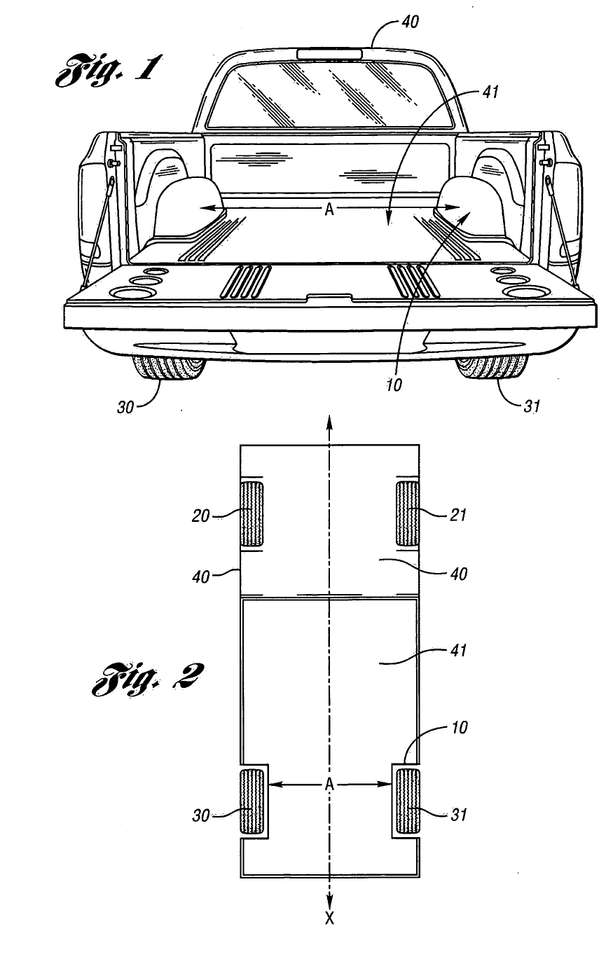

Prior art vehicles in common use are generally constructed so that the front wheels 20, 21 and the rear wheels 30, 31 are substantially inside the body (illustrated as two regions the cab 40 and the bed 41) of the vehicle with the rear wheels 30, 31 positioned to run directly in the tracks of the front wheels 20, 21 as illustrated in FIGS. 1, 2, and 3. As discussed in the BACKGROUND OF THE INVENTION, above, interior wheel wells increase the overall size of the bed area 41, but the single largest item that can fit into the bed is determined by the width A, the space between the wheel wells. The width A is generally about four feet in the largest vehicles to accommodate full sheets of building materials. Unfortunately, a rear seat about four feet wide is narrow, tight, and generally comfortably utilized only by children.

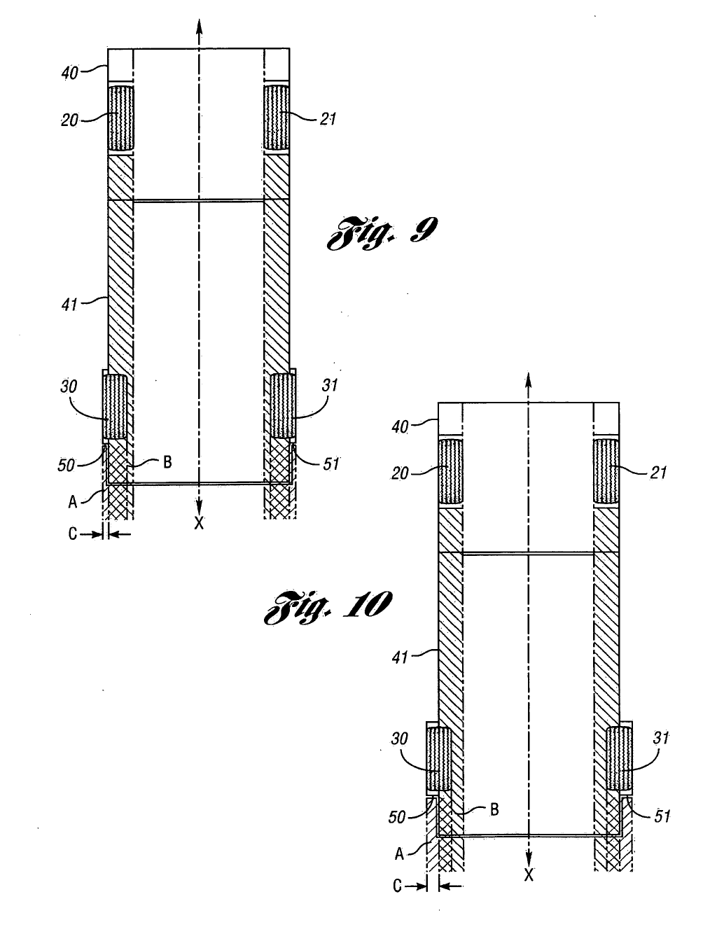

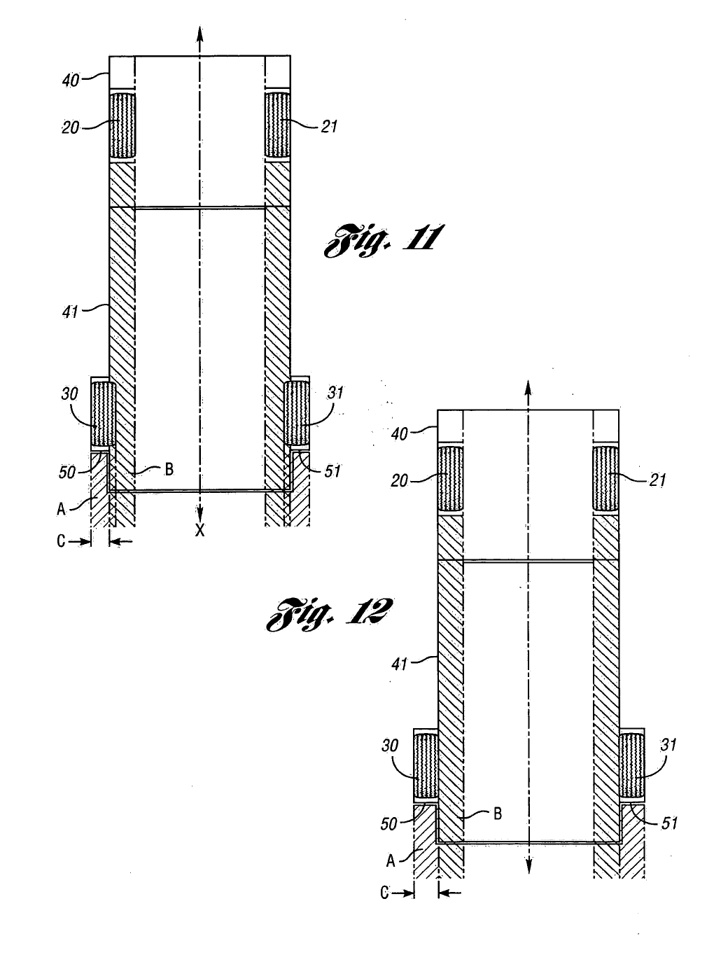

Embodiments of vehicles according to the present invention are illustrated in FIGS. 4, 5, 6, 7, and 8.

A vehicle according to the present invention has two front wheels 20, 21 and two rear wheels 30, 31. These wheels may be suspended in any manner. For example, these wheels may be independently suspended or paired on an axle. They may be driven using any system, for example, front wheel drive, rear wheel drive, four wheel drive, all wheel drive, and variations thereof.

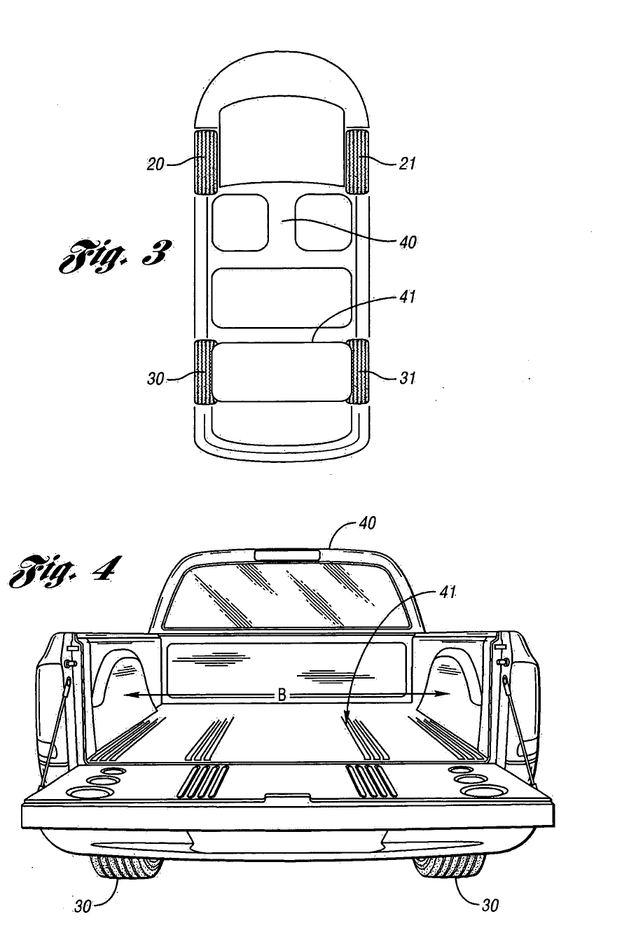

More specifically, the front wheels 20, 21 (also referred to as the first and second wheels, respectively) are fixed or mounted to the front portion of the frame or unibody so that they are parallel to the central longitudinal axis X (shown in FIGS. 2, 5, and 6) of the frame or unibody and parallel to each other.

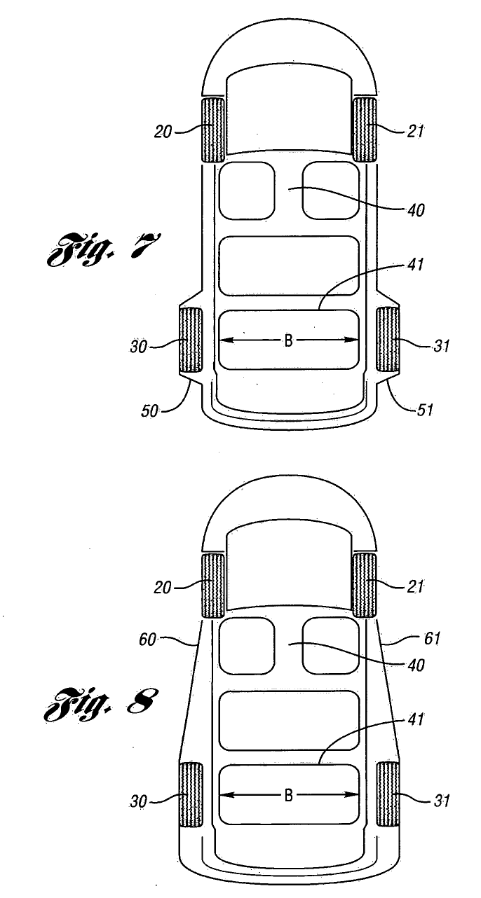

The rear wheels 30, 31 (also referred to as the third and fourth wheels, respectively) of a vehicle according to the invention are fixed or mounted to the frame or unibody parallel to the central longitudinal axis X and parallel to each other. In addition as specifically illustrated in FIGS. 5, 6, 7, and 8 the rear wheel 30 (the third wheel), is fixed outward of the front wheel 20 (the first wheel); and the rear wheel 31 (the fourth wheel), is fixed outward of the front wheel 21 (the second wheel).

As used herein, “outward” specifically means that the rear wheels 30, 31 are fixed farther outward from the central longitudinal axis X of the vehicle than the front wheels 20, 21 such that the rear wheels 30, 31 do not run in the tracks of the front wheels 20, 21, respectively. More specifically, when a vehicle according to the invention is moving in a straight line, the rear wheels 30, 31 should be fixed a sufficient distance outward compared to the front wheels 20, 21 that 25-100% of the track of rear wheels 30, 31 is outside the track of the front wheels 20, 21; preferably, 50-100% of the track of rear wheels 30, 31 is outside the track of the front wheels 20, 21; more preferably, 75-100% of the track of rear wheels 30, 31 is outside the track of the front wheels 20, 21; and most preferably, 100% of the track of rear wheels 30, 31 is outside the track of the front wheels 20, 21.

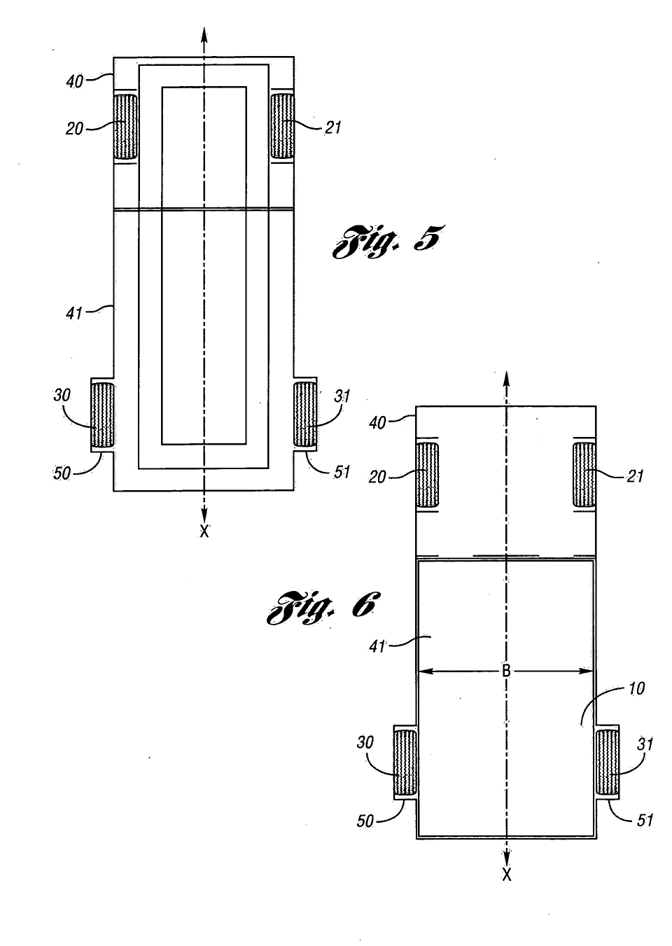

The cab 40 (or cab region in the case of vans, mini-vans, SUVs, and unibody vehicles) is fixed to the front portion of the frame or unibody covering the first wheel 20 and the second wheel 21. The rear bed 41 (or bed region in the case of vans, mini-vans, SUVs, and unibody vehicles) is fixed to the rear portion of the frame or unibody between the third wheel 30 and the fourth wheel 31. In the present invention, the interior of the rear bed 41 does not cover the third wheel 30 and the fourth wheel 31. Rather, the rear wheels 30, 31 extend outward from the front wheels 20, 21, and the rear wheels 30, 31 are enclosed in outwardly protruding wheel wells 50, 51. (The present invention specifically includes a vehicle body formed from the cab 40 and bed 41 which may be separate parts (i.e. in a pickup), regions of a one piece body (i.e. a unibody SUV or minivan), or variations thereof.) “Cover” or variations thereof as used herein means that a wheel is generally within the outline of the cab or cab region, bed or bed region, or the vehicle body. This does not mean that the entire wheel is enclosed by the body. Some portion of each wheel will extend beyond the body to support the vehicle, and may extend slightly depending on the curvature of the side body panels. (In the prior art, all four wheels 20, 21, 30, 31 of the vehicle are “covered.” In some embodiments of the present invention, only the front wheels 20, 21 are covered. (Compare, FIGS. 2 and 3 with FIGS. 5, 6, and 7.)

The unique configuration of the wheels in the present invention permits the rear bed 41 to have smooth interior walls that are uninterrupted by protruding rear wheel wells so that the rear bed is as wide as the vehicle body through its entire length. This is illustrated by width B in FIGS. 5, 6, 7, and 8.

A particularly advantageous aspect of the present invention is that it can be implemented without the cost of a major redesign on almost any vehicle currently in production. In practical terms, this means that prior art vehicles where dimension A is only around 4 feet could be reconfigured according to the present invention to have a usable width B of approximately be five feet. Thus, the present invention permits a wide bed vehicle, be it a pickup truck, truck, van, minivan, etc. to be easily and inexpensively manufactured without extensive retooling or redesign using, for the most part, off the shelf components. (Compare, FIGS. 1, 2 and 3, with FIGS. 4, 5, 6, 7, and 8.)

Further, if the starting vehicle is a “dualie” pickup truck that is already in production, the present invention is even less expensive to realize: simply replace the dual rear wheels with single rear wheels on the existing dual rear wheel axle, and replace the interior wheel boxes in the bed with stamped covers. (Compare, FIGS. 1 and 3.)

The added width of a vehicle of the present the present invention creates unprecedented width in the rear bed or rear bed region. For example, a pickup truck with a open bed according to the invention is wide enough to accommodate oversize items like a queen mattress flat on the bed, and two snowmobiles or three motorcycles side by side. A minivan or SUV according to the invention can be configured with a third row seat that is an exact duplicate of the second row seat; and a full size van can be configured without having to raise the floor almost to the top of the wheels to create interior width.

Vehicles according to the present invention are also easily configured to have a rear bed or bed area that can be raised or lowered. One way to achieve such a configuration is to configure the front wheels as the drive wheels and the rear wheels as independently suspended. The added width between the rear wheels in vehicles easily permits the addition of an appropriate mechanism can that will lower the rear bed from operational level almost to ground level. Any vehicle so configured is ideally suited for situations that requires roll on, roll off loading such as handicapped applications, package delivery, etc.

When a vehicle according to the present invention is based on smaller platforms, such as a compact pickup truck or mini SUV, the utility of such vehicles is significantly increased. For example, the increased width of the bed makes it possible to carry a full size sheet of plywood, or increase the width of the second seat and move it further toward the back of the vehicle (i.e. more between the rear wheels) thereby permitting three adults to sit comfortably and have adequate leg room.

Another factor that adds to the utility of vehicles fabricated according to the present invention is that the upper dimensions of such vehicles remain unchanged from the upper dimensions of the same model vehicle manufactured with the wheels in the standard configuration. This fact permits many of the same factory and aftermarket accessories to fit both standard and wide bed vehicles. For example, pickup bed tool boxes (such as described in U.S. Pat. No. 5,685,467), bed extenders (such as described in U.S. Pat. No. 6,513,850 B1), bed covers, toppers, etc.; and van, minivan, or SUV roof racks, roof cargo boxes, wind deflectors, etc. can easily be used for either application.

FIG. 8 illustrates another embodiment of the current invention. Rather than accommodating the rear wheels 30, 31 in protruding wheel wells, the vehicle sides 60, 61 are angled to form a continuous line from the area just behind the front wheels 20, 21 to the area just in front of the rear wheels 30, 31. This configuration makes the vehicle roughly wedge shaped in longitudinal cross section. While illustrated in a three row minivan or SUV configuration, this wedge shaped configuration is particularly applicable in passenger cars, sport wagons, and mini SUVs to permit an increase in the width of the rear seat, increased leg room, and overall increased interior volume.

It is may also be desirable to add additional features common on modern vehicles to vehicles of the present invention. In particular, the use of vehicle stability control systems (FSR, ASMS); anti-lock braking systems (ABS); drive slip control systems (ASR); etc. particularly systems that measure and compensate for yawing, pitching, or rolling, etc. (referred to herein as “vehicle stability control systems”) are advantageous. Such vehicle control systems are described in detail in U.S. Pat. Nos. 6,216,081; 6,220,095; and 6,533,367 the contents of which are specifically incorporated herein by reference.

From the foregoing one skilled in the art will understand that the present invention can be applied to a number of vehicle types and a number of vehicle body styles without departing from the spirit and scope of the present invention. While much of the discussion in the specification is directed toward larger utility vehicles such as pickup trucks, vans, minivans, and SUVs, this is in no way intended to limit the scope of the invention. The concepts discussed are intended to apply equally to compact pickup trucks, mini-SUVs, and even passenger cars without departing from the spirit and scope of the invention. The forms of the invention shown and described are to be taken as non-limiting embodiments and various changes and modifications may be made to the invention without departing from its spirit and scope as defined in the claims.

1. A wide bed vehicle comprising:
a frame having a front portion, a rear portion, and a central longitudinal axis;
a first wheel fixed to said front portion of said frame parallel to said central longitudinal axis;
a second wheel fixed to said front portion of said frame parallel to said first wheel and parallel to said central longitudinal axis;
a third wheel fixed to said rear portion of said frame parallel to said central longitudinal axis outward of said first wheel, such that a track made by said third wheel is outside a track made by said first wheel when said wide bed vehicle is traveling in a straight line;
a fourth wheel fixed to said rear portion of said frame parallel to said central longitudinal axis, parallel to said third wheel, and outward of said second wheel, such that a track made by said fourth wheel is outside a track made by said second wheel when said wide bed vehicle is traveling in a straight line;
a cab fixed to said front portion of said frame, covering said first wheel and said second wheel; and
a rear bed fixed to said rear portion of said frame between said third wheel and said fourth wheel, said rear bed enclosing said third wheel and said fourth wheel in outwardly protruding wheel wells.

2. The wide bed vehicle of claim 1, where tracks formed by said third wheel and said fourth wheel are 100% outside of tracks formed by said first wheel and said second wheel provided said wide bed vehicle is traveling in a straight line.

3. The wide bed vehicle of claim 1, where said cab and said rear bed are areas in a one piece vehicle body.

4. (cancelled)

5. (cancelled)

6. (cancelled)

7. (cancelled)

8. The wide bed vehicle of claim 1, further comprising a vehicle body configured to surround said cab, said rear bed area, and said protruding wheel wells.

9. The wide bed vehicle of claim 8, where said vehicle body extends in a single surface from said first wheel to said third wheel and from said second wheel to said fourth wheel.

10. (cancelled)

11. A wide bed vehicle comprising:
a frame having a front portion, a rear portion, and a central longitudinal axis;
a first wheel fixed to said front portion of said frame parallel to said central longitudinal axis;
a second wheel fixed to said front portion of said frame parallel to said first wheel and parallel to said central longitudinal axis;
a third wheel fixed to said rear portion of said frame parallel to said central longitudinal axis outward of said first wheel such that a track made by said third wheel is outside a track made by said first wheel when said wide bed vehicle is traveling in a straight line;
a fourth wheel fixed to said rear portion of said frame parallel to said central longitudinal axis, parallel to said third wheel, and outward of said second wheel, such that a track made by said fourth wheel is outside a track made by said second wheel when said wide bed vehicle is traveling in a straight line;
a cab area fixed to said front portion of said frame, covering said first wheel and said second wheel;
a rear bed area fixed to said rear portion of said frame between said third wheel and said fourth wheel.

12. The wide bed vehicle of claim 11, where tracks formed by said third wheel and said fourth wheel are 100% outside of tracks formed by said first wheel and said second wheel provided said wide bed vehicle is traveling in a straight line.

13. The wide bed vehicle of claim 11, where said cab area and said rear bed area are joined to form a one piece vehicle body.

14. (cancelled)

15. (cancelled)

16. (cancelled)

17. (cancelled)

18. The wide bed vehicle of claim 11, further comprising a vehicle body configured to surround said cab area and said rear bed area.

19. The wide bed vehicle of claim 18, where said vehicle body extends in a single surface from said first wheel to said third wheel and from second wheel to said fourth wheel.

20. (cancelled)

21. The wide bed vehicle of claim 1, where tracks formed by said third wheel and said fourth wheel are 25-100%, outside of tracks formed by said first wheel and said second wheel provided said wide bed vehicle is traveling in a straight line.

22. The wide bed vehicle of claim 1, where tracks formed by said third wheel and said fourth wheel are 50-100%, outside of tracks formed by said first wheel and said second wheel provided said wide bed vehicle is traveling in a straight line.

23. The wide bed vehicle of claim 1, where tracks formed by said third wheel and said fourth wheel are 75-100%, outside of tracks formed by said first wheel and said second wheel provided said wide bed vehicle is traveling in a straight line.

24. The wide bed vehicle of claim 11, where tracks formed by said third wheel and said fourth wheel are 25-100%, outside of tracks formed by said first wheel and said second wheel provided said wide bed vehicle is traveling in a straight line.

25. The wide bed vehicle of claim 11, where tracks formed by said third wheel and said fourth wheel are 50-100%, outside of tracks formed by said first wheel and said second wheel provided said wide bed vehicle is traveling in a straight line.

26. The wide bed vehicle of claim 11, where tracks formed by said third wheel and said fourth wheel are 25-100%, outside of tracks formed by said first wheel and said second wheel provided said wide bed vehicle is traveling in a straight line.
